(19) United States
(12) Patent Application Publication
(10) Pub. No.: US 2011/0046844 A1
(43) Pub. Date: Feb. 24, 2011

(54) SYSTEM AND METHOD FOR CHANGING THE STATE OF VEHICLE COMPONENTS

(76) Inventors: Mats Honner, Lindome (SE); Patrik Isaksson, Molndal (SE); Joakim Ohlsson, Vastra Frolunda (SE); Rolf Jarenmark, Molnlycke (SE); Jan Soderberg, Goteborg (SE); Hans Westerlind, Nol (SE); Jan Ronnlund, Kungsbacka (SE); Raphael Ribero, Lyon (FR); Rudi Alferi, Stockholm (SE)

Correspondence Address: WRB-IP LLP, 801 N. Pitt Street, Suite 123, ALEXANDRIA, VA, 22314, US

(21) Appl. No.: 12/739,156

(22) PCT Filed: Oct. 22, 2008
(86) PCT No.: PCT/SE08/00607

§ 371 Date: Aug. 31, 2010

(30) Foreign Application Priority Data
Oct. 22, 2007 (SE) 0702360-9

(51) Int. Cl. G06F 19/00

(52) U.S. Cl. 701/33

(57) ABSTRACT

An electronic/electric vehicle infrastructure system is provided for controlling the electronic/electric functions and/or functionalities of a vehicle as well as a method for controlling such a system, wherein the electronic/electric vehicle infrastructure system includes at least two electronic/electric vehicle infrastructure subsets each including a plurality of electronic/electric vehicle infrastructure elements, wherein an electronic/electric infrastructure element is an electronic control unit (ECU), a network segment and/or a load, and at least one electronic/electric vehicle infrastructure element is transferable in an active or inactive state, and wherein the electronic/electric functions and/or functionalities are defined by predetermined vehicle modes and/or predetermined applications needing predetermined ECUs and/or loads, wherein each ECU includes a state change component for transferring the ECU, at least one connected load and/or at least one network segment attached to the ECU into an active or inactive state, wherein each state change component is adapted to receive, transfer and/or execute a state transfer request initiated by a change of the current predetermined vehicle mode and/or by application needs.

### BACKGROUND AND SUMMARY

The present invention relates to an electronic/electric vehicle infrastructure system for controlling the electronic/electric functions and/or functionalities of a vehicle and a method for controlling such a system, wherein the electronic/electric vehicle infrastructure system comprises at least one electronic/electric vehicle infrastructure subsets each comprising a plurality of electronic/electric vehicle infrastructure elements, wherein an electronic/electric infrastructure element is an electronic control unit (ECU), a network segment and/or a load, and at least one electronic/electric vehicle infrastructure element is transferable in an active or inactive state, and wherein the activity of the electronic/electric functions and/or functionalities are defined by predetermined vehicle modes and/or predetermined application-specific contexts.

In order to reduce the power consumption in the vehicle, there is a need to develop infrastructure solutions that enable to fully power only electronic/electric infrastructure elements (ECUs, loads, network segments) that are required at the time. As vehicle functionality is to a large extent implemented by applications, this means that only these infrastructure components need to be fully powered which are required by certain applications.

There are solutions today that support activity control on an individual physical network segment. Those solutions are usually referred to as network management. For example, the PCT application WO 02/46895 discloses a control and regulation system for motor vehicles, wherein at least two control units connected via a data bus can be switched to specific power consumption modes in order to reduce power consumption. For this, one control unit comprises a power management module having a control program with an interface, via which data related to the specific power consumption modes can be transmitted to the control program for the optimal execution of existing applications programs. The specific power consumption modes are defined by a program in the control unit or by an external request. The control program itself comprises elements for calculating the power consumption modes required by the control unit from the power consumption data. Further, switching elements are provided which transfer the control unit from one power consumption mode to another.

Disadvantageous, the disclosed method and system can only be used for vehicles having a simple bus or network structure, particularly having only a single bus connecting all ECUs in the vehicle. In case a more complex bus structure having a plurality of network segments or infrastructure subsets is used, these subsets can only be individually controlled by the disclosed method. A possibility to activate more than one network segment with a single request is not possible. Additionally, for a Hardware (HW)-wire controlled activation of loads and/or other ECUs initiated by one ECU, only ad-hoc and application-specific solutions are known. Further, the disclosed power management module only controls the power state of an ECU, wherein the power states of loads and other control units connected and controlled by the same control unit cannot be controlled.

Another disadvantage of the existing solutions is that they are hardware dependent and strongly related to the existing infrastructure. That means, since the logical components or software components, which are necessary for executing specific applications, are not necessarily included in the same ECU in different vehicle, the logical components need to be identified for each vehicle type independently.

It is therefore desirable to provide a single framework for specifying and controlling the activity of a plurality of vehicle infrastructure subsystems and thereby the power consumption of the whole vehicle, i.e. all ECUs, loads and network segments.

According to aspect of the present invention, an electronic/electric vehicle infrastructure system for controlling the electronic/electric functions and/or functionalities of a vehicle and a method for controlling such a system are provided.

The invention is based on the main concept to provide in each ECU a special infrastructural component—a so called state change component, which is adapted to transfer the ECU, loads connected to this ECU and network segments attached to this ECU, i.e. the local infrastructure subset, into an active or inactive state. Thereby, not only the ECU but also the electronic/electric infrastructure subset can be transferred into an active or inactive state. Additionally, all those state change components are adapted to exchange information about the currently required vehicle activity, whereby the required vehicle activity is defined by global vehicle modes, such as parking, living, or running, or by predefined needs of applications. Furthermore, each state change component can request the transfer of one or more further infrastructural subsets into an active or inactive state. The state change information is propagated in the vehicle by the state change components transmitting the state transfer request to all ECUs, connected loads and attached network segments that are affected by the state transfer request.

The state change component itself can be a software element, particularly a middleware element, adapted to be executed by a software controlled element, such as a microprocessor or a CPU, comprised in the ECU, and/or a hardware logic element comprised by the ECU or the ECU'S software controlled element, such as a programmable logic device or a field programmable gate array.

According to a preferred embodiment of the invention, an ECU can have at least two inactive states which differ by power consumption and/or response time. That means, e.g. if an ECU has two inactive states, a stand-by state and a sleep state, the power consumption of the stand-by state could be higher than the power consumption of the sleep state. But on the other hand, the response time of the ECU to requests in the stand-by state could be much quicker than in the sleep state. Further, upon receiving the transfer request, the ECU can decide into which inactive state it will transfer. In a further preferred embodiment, if there is no need for an ECU to be active, the ECU can also be instructed into which inactive state to switch to when is should become inactive. Additionally, it is possible to change this instruction at any time during run-time to reflect different needs related to power consumption and/or response time.

Which electronic/electric vehicle infrastructure subset needs to be active or whether it can be transferred in an inactive state is preferably defined by “global” vehicle modes and/or by application needs. Thereby, for each application and/or each vehicle modes a corresponding subset of needed ECU's, loads and network segments are defined in so-called activation scenarios, which are preferably stored in a look up table.

In general, the “global” vehicle modes are modes on an overall vehicle level related to the operation of the whole vehicle, which are mostly related to the vehicle's overall power consumption. An exemplary set of vehicle modes is given in the following list, wherein the power consumption increases from the beginning of the list to its end.
Hibernate: storage and shipping (minimum power consumption)
Parked: vehicle is parked
Living: operator is resting in the vehicle
Accessory: operator is sitting in the driver's seat and is about to drive away
Pre-Running: Powertrain nodes have been supplied, but the engine has not yet been started
Cranking: the engine is cranking
Running: engine is running (maximum power consumption).
   In the following only three vehicle modes, namely Parked, Living, and Running, are exemplarily used. It goes without saying that any arbitrary number of vehicle modes can be define.

In a further preferred embodiment, the state change components are arranged in a tree hierarchical structure having a root state change component and at least one subordinate state change component, such as an intermittent state change component and/or a leaf state change component. The intermittent state change component can therefore be regarded as a superordinate state change component to at least one leaf state change component.

It is further preferred, that for each application a local state change component is defined which transmits a state transfer request to the state change components comprised in the ECUs needed by the application and/or in the ECUs connected to loads needed by the application and/or in the ECUs attached to network segments needed for the transmission of the state transfer request. Thereby, a transfer request from an application made to its local state change component is forwarded upwards to all superordinate state change components related to the request. The superordinate state change components then transmit a compiled state transfer request to all their subordinate state change components related to the request, whereby all state change components get an updated picture of the currently required infrastructure subsets and can therefore activate their ECU, connected loads and/or attached network segments, accordingly.

This network-communicated state transfer can preferably be performed by transmitting a state transfer message over the network segments attached to the ECU. Thereby, it is possible to transfer ECUs and loads into an active or inactive state which are connected to the same network segments as the ECU hosting the state change component, which has transmitted the transfer request.

As mentioned above, the activity of a specific set of vehicle function or functionalities as requested by application needs and/or vehicle modes can be captured by an activation scenario. The activation scenario is preferably hardware-independent and identifies all logical (software) components required to be active for a concerned function. Since these software components or logical components are executed by microprocessors or CPUs generally comprised in ECUs, the activation scenario also implicitly identifies all ECUs which are required to be active. When the allocation of the logical (software) components onto the ECUs is known, the necessary set of electronic/electric vehicle infrastructure subsets (ECUs, loads, network segments) required for the application or the vehicle mode can be identified in the activation scenario. Further, each activation scenario defined for a certain function and/or vehicle mode (e.g. Parked, Living and Running) specifies the required active logical components as well as conditions for their activation/deactivation.

In a further preferred embodiment, the activation scenarios are defined in the form of configuration data, which can be consulted by the state change component in each ECU at run-time. The configuration data can, without necessarily changing the ECU implementation (i.e. post-build), be updated to reflect changes in the infrastructural subsets that should be possible to activate.

In a further preferred embodiment of the invention, the activation scenarios are stored in a look-up table, preferably a static look-up table, that links the vehicle functions' needs for activation of logical components to the activation of the infrastructure required for the activation to be possible. This table can be consulted at run-time (e.g. by the state change components) to ensure the appropriate activation or the transmission of an appropriate state transfer request.

The state change component is preferably enabled to locally initiate activation of the ECU itself and its locally controlled loads, to activate a network segment the ECU is connected to, to perform a wire-controlled activation of another ECU or load, to perform a network-communicated activation of another ECU or load, and/or to request gateway activation.

For activating an ECU or load, a specific hardware wire line control can be provided which is adapted to perform an activation/deactivation of hardware wire lines, which are used as activation lines, when the state change component receives an activation request for an infrastructure subset that includes the ECU or load. For the transfer of the ECU or a load into the active or inactive state by means of the activation line, the ECU or load to be activated can be powered, e.g., using a relay solution controlled by the activation line. The ECU or load could also be woken up from the inactive state by an activation line connected to an interrupt-triggering line of e.g. a network controller or microcontroller in the ECU.

For the locally initiated activation, the state change component preferably keeps the ECU running as long as there are internal ECU application requests to run or state change components in other ECUs require it to be running. If no requests or needs are present, the ECU can be transferred into the inactive state or low power state, particularly into a shut down state, a sleep state or a stand-by state.

Preferably, the inactive state or low power state of the ECU is in relation to the current vehicle mode. At run-time, the microprocessor or the CPU of the ECU can be re-configured, whenever the vehicle mode is changed. Thereby, it is possible that the ECU can enter a specific inactive state, when it is deactivated the next time.

The different inactive states differ, as explained above, by their power consumption and/or their response time to requests. Additionally, the different inactive states define how an ECU can be reactivated. For example, an ECU in a stand-by state can be woken up by sensor activity, wherein, in a sleep state, it can be woken up only by bus traffic. That means, in the stand-by state, the ECU can monitor sensor activity, wherein, in the sleep state, the ECU can only monitor bus activity.

Additionally, for the activation of a network segment, all network segments to which an ECU is connected to can be activated by the ECU'S state change component in order to make other ECUs or loads reachable.

In a further preferred embodiment, each state change component can propagate transfer requests received on one network segment or via a dedicated activation lines to other network segments or activation lines attached to the ECU. For that, the dedicated activation lines are adapted to uniquely identify the concerned infrastructural subset. In this way, it is possible to propagate transfer requests from one network segment to any other network segment via one or more (gateway) state change components.

Further advantages and preferred embodiments are described herein.

### BRIEF DESCRIPTION OF THE DRAWINGS

In the following the invention will be described in more detail with reference to the attached figures. The embodiments shown in the figures are exemplary only and are not intended to limit the scope of the invention thereto.

The figures show:

FIG. 1: a preferred embodiment of an electronic/electric vehicle infrastructure system according to the invention comprising a plurality of infrastructure subsystems;

FIG. 2: an exemplary distribution of logical (software) components executed by ECUs over a part of the electronic/electric vehicle infrastructure subsystem according to FIG. 1; and

FIG. 3: a preferred embodiment for an activation scenario of more than one vehicle infrastructure subset.

### DETAILED DESCRIPTION

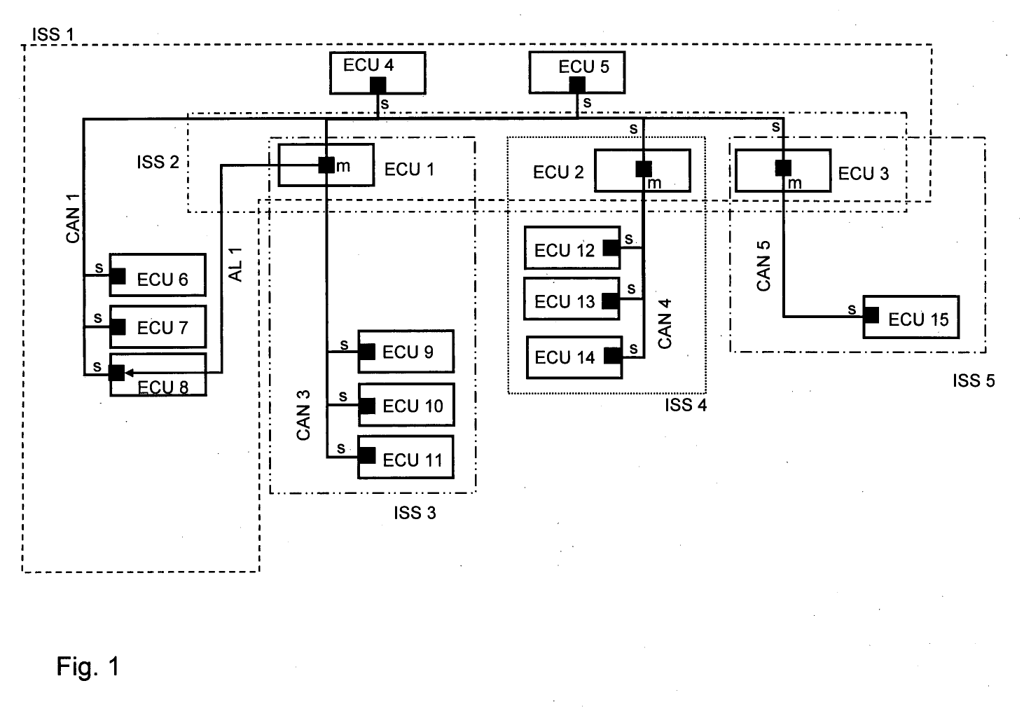

FIG. 1 shows a preferred embodiment of an electronic/electric vehicle infrastructure system according to the invention comprising a plurality of infrastructure subsystems ISS1 which are indicated by ISS1, ISS2, ISS3, ISS4 and ISS5. The shown five infrastructure subsets are exemplary only, since a vehicle infrastructure system can comprise easily more than 30 infrastructure subsystems. Each infrastructure subsets can comprise an arbitrary number of electronic control units (ECU1-ECU15), loads connected to the ECU (not shown), and/or network segments (CAN1-CAN5), particularly bus systems. In the shown embodiment a network segment is a CAN bus connecting ECUs. It should also be noted that ECUs and network segments can be part of more than one infrastructure subsystem, i.e. different infrastructure subsystems can overlap.

The vehicle's electronic/electric infrastructure provides the electric and/or electronic functions or functionalities of the vehicle which in turn can be provided by applications e.g. defined by software programs being executed in the microprocessors or CPUs of the electronic control units. Preferably, the infrastructure subset is defined as a subset of the vehicle's electronic/electric infrastructure components (ECUs, loads, network segments) which should be activated together for providing certain vehicle functions or functionalities. Since activation of a network segment also results in an activation of ECUs, it makes no sense to specify an infrastructure subset that only includes these ECUs, which, for example, cannot be activated/deactivated in relation to the activation of the network segment. To avoid that, the set of infrastructure subsystems are preferably established early in the infrastructure system design.

According to the invention, each ECU (ECU1-ECU15) comprises a state change component which is indicated by a black rectangle in FIG. 1. The state change component is adapted to transfer the corresponding ECU into an active or inactive state. Further, the state change components are adapted to activate/deactivate loads connected to the ECU and/or attached network segments and can communicate with each other for receiving, transferring and/or executing a state transfer requests initiated by a change of the current predetermined vehicle modes and/or by application needs.

Since each application needs a specific set of logical or software components, which can be executed in the same and/or in different ECUs, for providing the application based function or functionality of the vehicle, the activation scenarios specify for each application the necessary logical components. Since the logical components can be spread over a plurality of ECUs, a map is necessary which links the needed logical components of an application to the ECUs incorporating the logical devices and to the infrastructure subsets, which comprise the corresponding ECUs. Preferably, such a map is a look-up table, which can be consulted at run-time. In a preferred embodiment, the state change component comprises a memory for storing different activation scenarios as well as such a map for the activation of infrastructure subsets.

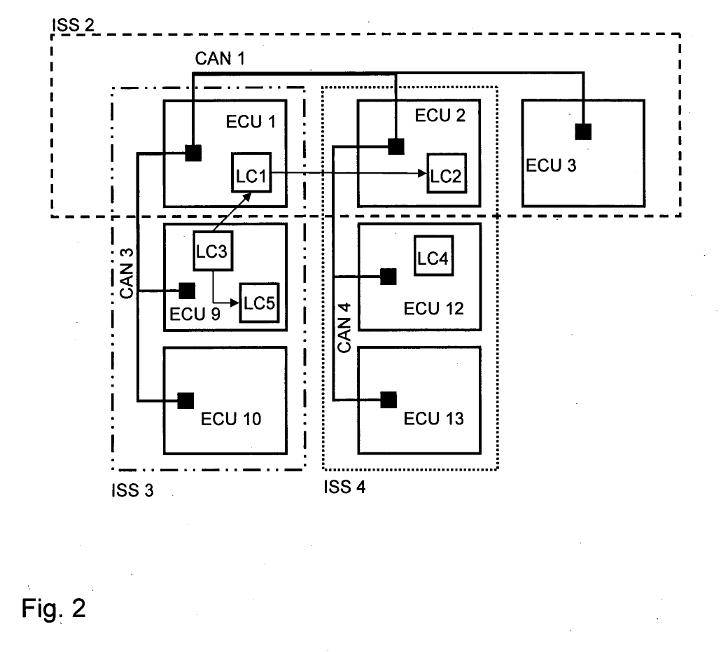

FIG. 2 shows schematically, a situation where for a certain application four logical software components LC1, LC2, LC3 and LC5 are needed. The illustrated infrastructure system is only a part of the infrastructure system shown in FIG. 1, comprising only ECU1, ECU2, ECU3, ECU9, ECU10, ECU12 and ECU13, wherein ECU1, ECU2 and ECU3 are defining infrastructure subset ISS2, ECU1, ECU9 and ECU 10 define infrastructure subset ISS3, and ECU2, ECU 12, ECU 13 form infrastructure subset ISS4. The software components LC1-LC5 are not incorporated in a single ECU but, as can be seen in the illustrated example, are incorporated in ECU1 (LC1), ECU2 (LC2) and ECU9, whereby ECU9 comprises two software components (LC3 and LC5). LC4 is incorporated in ECU 12 and need not be activated. For executing the application, therefore infrastructure subsets ISS2 and ISS3 need to be activated, wherein ISS4 can remain in an inactive state. As soon as ECU1, ECU2 and ECU9 are activated, they can execute software components LC1-LC3, and LC5, so that the application can be performed.

In the following table, the infrastructure subsets and their corresponding ECUs and connecting CAN busses as illustrated in FIG. 1 are indicated. Additionally, FIG. 1 and the table show that at least two ECUs can be coupled by a direct hardware wire. In the present embodiment ECU1 and ECU8 are connected to each other by a direct dedicated activation line AL1.

| | | Network | |
|---|---|---|---|
| ISS | ECUs | segments | HW Lines |
| ISS1 | ECU1, ECU2, ECU3, ECU4, ECU5, | CAN1 | AL1 |
| | ECU6, ECU7, ECU8. | | |
| ISS2 | ECU1, ECU2, ECU3 | CAN1 | — |
| ISS3 | ECU1, ECU9, ECU10, ECU11 | CAN3 | — |
| ISS4 | ECU2, ECU12, ECU13, ECU14 | CAN4 | — |
| ISS5 | ECU3, ECU15 | CAN5 | — |

Preferably, the ECUs and therefore also the state change components are arranged in a hierarchical tree structure, as illustrated in FIG. 1, where ECU1 can be regarded as root or master ECU. ECU 2 and ECU3 can be regarded as intermediate tree nodes to ECU1, wherein ECU4 and ECU 5 as well as ECU 6, ECU7, ECU8, and ECU9, ECU 10, ECU11 can be regarded as leaf nodes to ECU1. An intermediate node tree node is i.e. an ECU acting as slave to a superordinate ECU and as master to at least one subordinate ECU, wherein a leaf node is i.e. an ECU with only one communication link, thereby having only superordinate ECUs. The intermediate nodes ECU 2 and ECU 3 themselves act as master for their leaf nodes ECU 12, ECU13, ECU14, and ECU 15, respectively. The ECUs and thereby also the state change components are connected via network segments CAN1, CAN2, CAN5 and CAN4 to each other, which are e.g. data bus systems, particularly CAN busses.

Instead of a hierarchical tree structure, as described above, it is also possible to use a structure in which between any pair of ECUs1 or state change components, in the vehicle, there is exactly one communication path for exchanging data, particularly state transfer requests. That means, a case in which two ECUs are connected to the same two data buses does not exist. The rationale for this is that, if there would be more than one path, then a state transfer request could be sent between two ECUs for an infinite amount of time as there is no way to know when all ECUs have received the request. If there is only one path, the transmission of the request will automatically stop when the request reaches a leaf node. In this particular case, it is sufficient for each state change component to propagate an incoming activation request only on one communication link (e.g. a data bus or a hardwired link) to all other communication links it is connected to provided that they are part of the infrastructure subset specified by the activation request.

The above described hierarchical tree structure for the ECUs also defines the hierarchical tree structure of the state change components incorporated in the ECU. That means e.g. the state change component incorporated in root ECU1 is also defined as root state change component. Thereby it acts as master m to subordinated intermediated state change components incorporated in ECU2 and ECU 3 as well as to leaf state change components in ECU4 and ECU 5 as well as in ECU 6, ECU7, ECU8, and ECU9, ECU10, ECU11, and so on.

Even if ECU 1 acts as master to all other ECUs, it must not be incorporated in the same infrastructure subset as its subordinate ECUs. As can be seen in FIG. 1, infrastructure subset ISS1 connects by means of network segment CAN1, master ECU1 and the subordinate ECU2, ECU3, ECU4, ECU 5 as well as ECU6, ECU7, ECU8. A different infrastructure subset ISS2 is defined for ECU1, ECU2, and ECU3, which are also connected by CAN1. Further, infrastructure subsets ISS4 and ISS5, respectively, do not comprise master ECU 1 at all, but still can be defined as infrastructure subset. Propagation of activation requests are always limited to be within the infrastructure subsets that are requested, in order to avoid waking up (activating) the whole vehicle whenever an state transfer request is made. This also means that a state change component is only aware of the state transfer requests related to infrastructure subsets that its hosting ECU is part of.

It can be further seen in FIG. 1, that the intermediate nodes ECU2 and ECU3 and thereby also the incorporated state change components are slaves to the master ECU1, but act as master m to their directly connected leaf nodes ECU 12, ECU 13, ECU 14, and ECU 15, respectively.

Transfer requests made by applications or vehicle modes for transferring any infrastructure subset ISS into an active or inactive state are always made to a local state change component incorporated in the same ECU as the requesting logical (software) component. In order to inform all other ECUs and state change components, respectively, of the state transfer, the request is forwarded upwards in the hierarchy to all superordinate state change components as required for the request. That means if transfer request is initiated from e.g. ECU15, its incorporated and thereby local state change component transfers ECU 15 in an active state (a requesting ECU must always be included in the transfer request and, consequently, ECU 15 should become active itself as a part of the ISS activation) and then forwards the transfer request to its superordinate state change component incorporated in ECU3. The state change component of ECU3 then forwards the transfer request to its superordinate state change component which is root state change component incorporated in ECU 1. The root state change component then sends compiled request information downwards to all subordinated state change components incorporated in ECU4, ECU5, ECU6, ECU, 7, ECU8, ECU9, ECU 10, ECU11 and ECU2, ECU3, which in turn forward the request to their subordinated state change component incorporated in ECU12, ECU13, ECU 14 and back to the state change component ECU15. In this way, all state change components will have an updated picture of the currently active infrastructure subset ISS5 and can activate—if needed or requested—their local infrastructure, namely the hosting ECU and the loads attached to the ECU, accordingly.

Upon receiving information that an infrastructure subset has been transferred in the inactive state, the state change component in the concerned ECU will decide whether, as a result of the inactivation of the infrastructure subset, the ECU shall become inactive or not. It should be noted that an ECU can only become inactive if there are no pending requests in which it is included. An inactivation request can be triggered by e.g. global vehicle modes such as the vehicle is parked or if an ECU is not requested for a certain amount of time. Further, it is possible to define a plurality of inactive states for an ECU, which differ by power consumption and/or response time to requests.

For example, three ECU states can be defined—an active state and two inactive states, e.g. a stand-by state and a sleep state. Each state defines the tasks or functions an ECU can perform. In the active state, the ECU is fully powered and all possible ECU functions are provided if requested. The active state is typically used during the global vehicle state “Running”.

In the inactive state, only inputs (e.g. sensor input or data buses) connected to the ECU and related to selected or no ECU functions can trigger a change to the active state. In case the function is requested (i.e. inputs related to the function triggers the ECU), it takes a certain amount of time until the ECU responds. This response time can even be noticeable by a driver. Inactive states are typically used, if the vehicle is parked or in storage. Since there are scenarios in which the vehicle is not driving, but the driver is still inside, it is not desirable that certain vehicle function are not possible to activate any more, or it takes a noticeable amount of time to activate a function. E.g. in case a driver waits for a passenger with the vehicle not running, he/she might want to listen to music. Then, a driver might be annoyed, if the radio ON/OFF button only responses after some time. On the other hand in case the driver has just entered the vehicle, a noticeable response time for the ON/OFF button of the radio might be acceptable.

Consequently, the invention suggests defining at least two inactive states, wherein e.g. in case of a two-inactivity state embodiment a stand-by state and a sleep state are defined. The stand-by state can e.g. be used in case the vehicle is not running but the driver is still inside. The overall goal of this state is to save power by deactivating ECU functions. The ECUs can be adapted to enter the stand-by state after typically few seconds of inactivity. In the stand-by state, the ECU is still able to detect a function request from a driver or the vehicle itself, and can be transferred to the active state in reasonable short amount of time.

The sleep state can be typically be used if the vehicle is parked or in storage. The overall goal of this state is also to save power, but to a much higher amount than in the stand-by state, whereby the ECU functions are not active and not even requestable. In this state the ECU is not able to directly (on its own) detect a function request by driver or vehicle, and can be transferred to the active state only in a noticeable amount of time after being woken up by bus communication from other ECUs.

In the following table the three different states of ECUs and their characteristics are shown, wherein the active state is compared to two inactive states—a stand-by state and a sleep state.

| | | Inactive state | |
|---|---|---|---|
| ECU State | Active state | Stand-by | Sleep |
| ECU function | All ECU functions | Only selected ECU | ECU functions |
| | enabled (i.e. their | functions enabled | disabled (i.e. no |
| | function-related | (i.e. their function- | function-related |
| | inputs connected to | related inputs | inputs connected to |
| | the ECU are | connected to the | the ECU can wake it up) |
| | active); | ECU can wake it | |
| | All functions active, | up); | |
| | if allowed by its | Functions not | |
| | conditions | active | |
| Digital & Analog | All ECU inputs | Only selected ECU | No ECU inputs |
| Input handling | | inputs | |
| Output | All ECU outputs | ECU outputs | ECU outputs |
| engagement | | cannot be handled | cannot be handled |
| Communication | Broadcast and | Monitor I/O and | Monitor bus activity |
| Data bus | receive data | bus activity | |
| interfaces | | | |
| State entering | Internal ISS | No internal or | No internal or |
| possibilities | request | external ISS | external ISS |
| | External ISS | requests | requests |
| | request (via digital | ECU instructed to | ECU instructed to |
| | input or data | go to this state | go to this state |
| | communication bus | when becoming | when becoming |
| | info) | inactive | inactive |
| State leaving | Internal ISS | Internal ISS | Internal ISS |
| possibilities | request | request (after being | request (after being |
| | External ISS | woken up by I/O) | woken up data |
| | request (via digital | External ISS | communication |
| | input or data | request (via digital | bus) |
| | communication bus | input or data | External ISS |
| | info) | communication bus | request (via data |
| | | info) | communication bus |
| | | | info) |

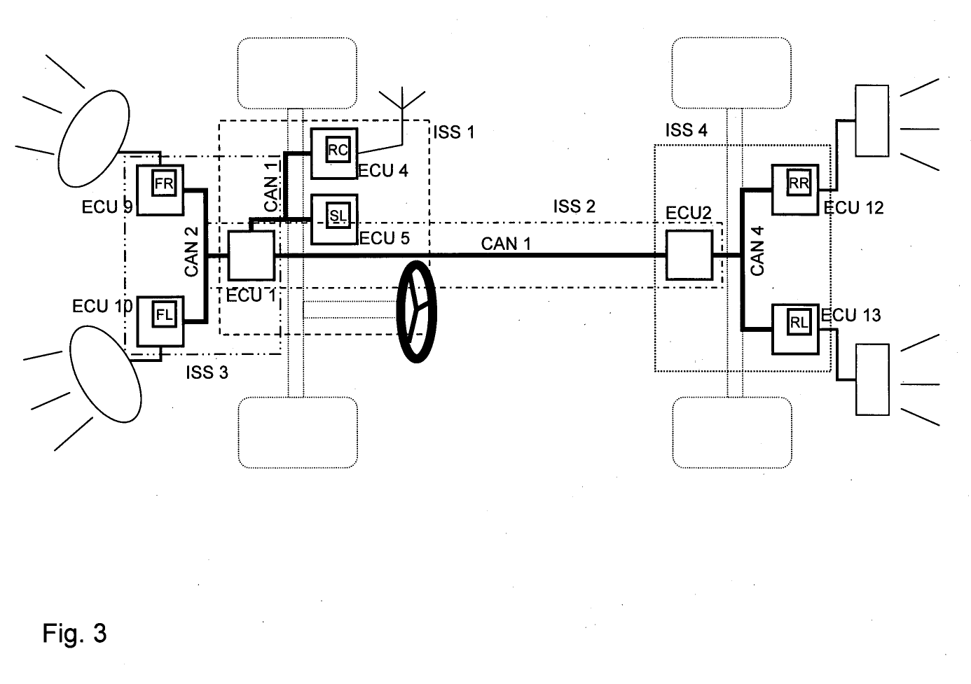

In FIG. 3, an activation scenario of a subset of state change components and their corresponding ECUs and loads is described in more detail. Thereby, the components of the vehicle infrastructure system as shown in FIG. 1 are exemplarily related to a special vehicle function, namely a security light function. Thereby, the vehicle's surroundings are illuminated in order to detect an intrusion or an intrusion attempt. The security light function can e.g. be triggered by a remote activation.

The logical or software components for performing the security light function are e.g. a security light controller (SL) for performing the function, a front right light control FR, a front left light control FL, a rear right light control RR, and a read left light control RL, for illuminating the vehicle, and a remote communication control RC for receiving an external request for initiating the security light function. For performing the security light function, all these components and the ECUs comprising the logical components need to be active. Therefore the corresponding activation scenario defines that for performing the security light function the logical component set of {RC, SL, FL, FR, RR, RL} need to be activated. The mapping/allocation of the activation scenario onto infrastructure further defines that the indicated logical components are included in a corresponding set of ECUs {ECU4, ECU5, ECU 10, ECU9, ECU 12, ECU 13}. All these ECUs need to be activated for performing the security light function. It should be noted that each activation scenario can be specified independently of the vehicle's infrastructure subsystem and that a mapping onto infrastructure activation can be made as soon as the allocation of logical components in the ECUs is known. Therefore the application scenario can be used for a plurality of vehicles.

Since the necessary ECUs are not necessarily in the same infrastructure subset, the activation scenario also links the necessary ECUs to the network segments which need to be activated. As illustrated in FIG. 1, ECU 4 and ECU5 are part of infrastructure subsystem ISS1, wherein ECU9 and ECU 10 are part of infrastructure subsystem ISS3, and ECU 12 and ECU 13 are part of infrastructure subsystem ISS4. Since ISS 1 and ISS3 both comprise the same superordinate ECU1, activation of infrastructure ISS1 also activates ECU1 which in turn can activate infrastructure subsystem ISS3. But, ECU 12 and ECU 13 cannot be directly activated by ECU1, as they are not directly connected to it. ECU 12 and ECU13 are slaves to ECU2 which is subordinated to ECU1. Unfortunately, ECU2 is comprised in a further infrastructure subsystem ISS2. Consequently, for activating ECU12 and ECU 13, it is necessary to firstly activate ISS2 and ECU2, and then ISS4 which the comprised ECU 12 and ECU 13.

The activation scenario for performing security light illumination is triggered by an external request received by ECU4 comprising RC. ECU4 comprising RC then transmits a need for activation the security lights are transmitted to the security light controlling ECU5. ECU5 consults the activation scenario stored in a look-up table and then transmits a state transfer request, particularly an activation request, to its superordinate ECU1. ECU1 in turn transmits the request to ECU9, ECU10 and ECU2, whereby ECU2 further transmits the state transfer request to ECU12 and ECU13. In the end, all necessary ECUs are activated.

The communication of transfer requests can, for example, be performed by using an already existing network management as a transport media (by e.g. embedding the information in the network management messages usually sent by the network management) but all other distribution possibilities can be used.

The invention can be made an integral part of any ECU and/or system configuration tools. Furthermore, it is possible to re-use the implementation of the infrastructure and application activation as specific components to be embedded in each ECU.

In addition use of the invention allows standardisation of specification, design and implementation of the activation of all applications, loads, network segments and ECUs in the whole vehicle. This will reduce integration problems due to application-specific sub-system solutions. It will also be possible to re-use application and middleware software to a larger extent. Full traceability of function activity down to implementation will be possible. Furthermore, configuration of the infrastructure use (ECUs and networks) due to changed application activation needs can be automatically generated from the updated application descriptions and will normally require no changes in the infrastructure as this is controlled by configuration data in the ECUs.

1. An electronic/electric vehicle infrastructure system for controlling the electronic/electric functions and/or functionalities of a vehicle, the vehicle infrastructure system comprising one or more electronic/electric vehicle infrastructure subsets each comprising a plurality of electronic/electric vehicle infrastructure elements, wherein an electronic/electric infrastructure element is an electronic control unit (ECU), a network segment and/or a load, and at least one electronic/electric vehicle infrastructure element is transferable in an active or inactive state, and wherein the electronic/electric functions and/or functionalities are defined by predetermined vehicle modes and/or application-specific contexts, wherein the electronic/electric functions and/or functionalities of the vehicle are provided by applications, each needing a specific set of logical components, which are allocated on the ECUs of the vehicle infrastructure system, wherein the electronic/electric vehicle infrastructure system further includes a map which links the needed logical components of an application to the ECUs incorporating the logical devices and to the infrastructure subsets, which comprise the corresponding ECUs, in that each ECU comprises a state change component for transferring the ECU, at least one connected load and/or at least one network segment attached to the ECU into an active or inactive state, wherein each state change component is adapted to receive, transfer and/or execute a state transfer request initiated by a change of the current predetermined vehicle mode and/or by application needs, and in that for each application a local state change component is defined which is arranged to transmit the transfer request to the state change components determined by the map.

2. The system according to claim 1, wherein the state change component is a (software) element adapted to be executed by a software controlled element comprised in the ECU, and/or a hardware logic element comprised by the ECU or the ECU's software controlled element.

3. The system according to claim 1, wherein for each electronic/electric vehicle infrastructure element at least two inactive states are defined which differ in a power consumption of the electronic/electric vehicle infrastructure element and/or a response time of the electronic/electric vehicle infrastructure element.

4. The system according to claim 1, wherein for each application and/or each vehicle mode a corresponding infrastructure subset of needed ECUs, loads and network segments are defined, particularly by the definition of an activation scenario, which is preferably stored in a look up table in each ECU.

5. The system according to claim 4, wherein the activation scenario further identifies the logical components required for each application and/or each vehicle mode, wherein this identification is preferably a mapping and/or a configuration of the activation scenario onto the infrastructure subset activation.

6. The system according to claim 1, wherein the ECU further comprises a digital input/output component for receiving/transmitting the transfer request and/or a COM control component being in communication with the state change component for activating/deactivating a network segment, particularly a data bus system comprising wired and wireless ports.

7. The system according to claim 1, wherein the state change components are arranged in a hierarchical tree structure comprising a root state change component, at least one intermittent state change component and/or at least one leaf state change component, and/or wherein the electronic/electric vehicle infrastructure is arranged in a hierarchical tree structure, wherein optionally the hierarchical tree structure of the state change components and the hierarchical tree structure of the vehicle infrastructure differ.

8. The system according to claim 7, wherein for each application a local state change component is defined, which is adapted to transmit/receive the state transfer request to/from a superordinate state change component.

9. The system according to claim 1, further comprising a vehicle mode master comprising the predetermined vehicle modes, particularly parked, living and/or running, stored in a look up table, wherein preferably the vehicle mode master is in communication with the root state change component for distributing the predetermined vehicle mode to all subordinated state change components.

10. Method for transferring an electronic/electric vehicle infrastructure system for controlling the electronic/electric functions and/or functionalities of a vehicle into an active or inactive state, wherein the electronic/electric vehicle infrastructure system comprises at least two electronic/electric vehicle infrastructure subsets each comprising a plurality of electronic/electric vehicle infrastructure elements, wherein an electronic/electric infrastructure element is an electronic control unit (ECU), a network segment and/or a load, and at least one electronic/electric vehicle infrastructure element is transferable in an active or inactive state, and wherein the electronic/electric functions and/or functionalities are defined by predetermined vehicle modes and/or application-specific contexts, wherein the electronic/electric functions and/or functionalities of the vehicle are provided by applications, each needing a specific set of logical components, which are allocated on the ECUs of the vehicle infrastructure system, wherein the electronic/electric vehicle infrastructure system further includes a map which links the needed logical components of an application to the ECUs incorporating the logical devices and to the infrastructure subsets, which comprise the corresponding ECUs, in that each ECU comprises a state change component for transferring the ECU, at least one connected load and/or at least one network segment attached to the ECU into an active or inactive state, wherein each state change component is adapted to communicate with each other, the method comprising the steps of:
receiving by means of the state change component a transfer request initiated by a change of the current predetermined vehicle mode or by application needs;
transferring by means of the state change component the transfer request to another state change component, and/or
executing by means of the state change component the transfer request by transferring the ECU, at least one connected load and/or at least one network segment attached to the ECU into an active or inactive state, and in that for each application a local state change component is defined which is transmit the transfer request to the state change components determined by the map.

11. The method according to claim 10, wherein an electronic/electric vehicle infrastructure system according to claim 1 is used.

12. The method according to claim 10, wherein for each application and/or each vehicle mode a corresponding infrastructure subset of needed ECU's, loads and network segments are defined, particularly by the definition of an activation scenario, which is preferably stored in a look up table in each ECU.

13. The method according to claim 12, wherein the activation scenario further identifies the logical components required for each application and/or each vehicle mode, wherein this identification is preferably performed by a mapping and/or by a configuration of the activation scenario onto the infrastructure subset activation

14. The method according to claim 10, wherein for each application a local state change component is defined which transmits a transfer request to the state change components comprised in the ECUs needed by the application and/or the ECUs connected to loads needed by the application and/or the ECU's attached to network segments needed for the transmission of the state transfer request.

15. The method according to claim 10, wherein the vehicle mode, particularly parked, living and/or funning, is communicated to a root state change component which transmits a transfer request to all state change components.
